(19) United States
(12) Patent Application Publication
(10) Pub. No.: US 2026/0369250 A1
(43) Pub. Date: Nov. 19, 2026

(54) ELECTRONIC DEVICE, METHOD, AND NON-TRANSITORY COMPUTER-READABLE STORAGE MEDIUM FOR CONTROLLING BRIGHTNESS LEVEL

(71) Applicant: Samsung Electronics Co., Ltd., Suwon-si (KR)

(72) Inventors: Minwoo LEE, Suwon-si (KR); Unggyu KIM, Suwon-si (KR); Seoyoung LEE, Suwon-si (KR); Donghwy KIM, Suwon-si (KR); Kwangtai KIM, Suwon-si (KR); Donghyun YEOM, Suwon-si (KR)

(21) Appl. No.: 19/721,999

(22) Filed: Jun. 26, 2026

Related U.S. Application Data
(63) Continuation of application No. PCT/KR2024/017848, filed on Nov. 12, 2024.

(30) Foreign Application Priority Data
Jan. 2, 2024 (KR) 10-2024-0000596
Jan. 17, 2024 (KR) 10-2024-0007319

(51) Int. Cl. G09G 5/10

(52) U.S. Cl. CPC G09G 5/10; G09G 2320/0233; G09G 2320/0626; G09G 2360/144

(57) ABSTRACT

An electronic device is provided. The electronic device includes memory, including one or more storage media, storing instructions, an illuminance sensor, a display, and one or more processors communicatively coupled to the memory, the illuminance sensor, and the display, wherein the instructions, when executed by the one or more processors individually or collectively, cause the electronic device to detect an event for displaying a first image, based on the event, obtain a second image that includes a third area corresponding to a first area of the first image, the third area being brighter than the first area, and a fourth area corresponding to a second area of the first image, the fourth area being darker than the second area, control a brightness level of the display displaying the second image by setting a value for compensating for the fourth area being darker than the second area as a first value, and while the second image is displayed, based on recognizing, via the illuminance sensor, that an ambient illuminance around the electronic device is changed from a first illuminance lower than a first illuminance threshold to a second illuminance higher than the first illuminance threshold, control the brightness level of the display by setting the value as a second value lower than the first value.

### CROSS-REFERENCE TO RELATED APPLICATION(S)

This application is a continuation application, claiming priority under 35 U.S.C. § 365(c), of an International application No. PCT/KR 2024/017848, filed on Nov. 12, 2024, which is based on and claims the benefit of a Korean patent application number 10-2024-0000596, filed on Jan. 2, 2024, in the Ministry of Intellectual Property (MOIP), and of a Korean patent application number 10-2024-0007319, filed on Jan. 17, 2024, in the Ministry of Intellectual Property (MOIP), the disclosure of each of which is incorporated by reference herein in its entirety.

### BACKGROUND

### 1. Field

The disclosure relates to an electronic device, a method, and a non-transitory computer-readable storage medium for controlling a brightness level.

### 2 Description of Related Art

An electronic device may include a display. The display may be used to display an image. For example, the electronic device may support a function of controlling a brightness level of the display in accordance with a change in an ambient illuminance around the electronic device.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for controlling a brightness level.

Additional aspects will be set forth in part in the description which follows and, in part, will be apparent from the description, or may be learned by practice of the presented embodiments.

In accordance with an aspect of the disclosure, an electronic device is provided. The electronic device includes memory, including one or more storage media, storing instructions, an illuminance sensor, a display, and one or more processors communicatively coupled to the memory, the illuminance sensor, and the display, wherein the instructions, when executed by the one or more processors individually or collectively, cause the electronic device to detect an event for displaying a first image, based on the event, obtain a second image that includes a third area corresponding to a first area of the first image, the third area being brighter than the first area, and a fourth area corresponding to a second area of the first image, the fourth area being darker than the second area, control a brightness level of the display displaying the second image by setting a value for compensating for the fourth area being darker than the second area as a first value, and while the second image is displayed, based on recognizing, via the illuminance sensor, that an ambient illuminance around the electronic device is changed from a first illuminance lower than a first illuminance threshold to a second illuminance higher than the first illuminance threshold, control the brightness level of the display by setting the value as a second value lower than the first value.

In accordance with another aspect of the disclosure, a method performed by an electronic device with an illuminance sensor and a display is provided. The method includes detecting an event for displaying a first image, based on the event, obtaining a second image that includes a third area corresponding to a first area of the first image, the third area being brighter than the first area, and a fourth area corresponding to a second area of the first image, the fourth area being darker than the second area, controlling a brightness level of the display displaying the second image by setting a value for compensating for the fourth area being darker than the second area as a first value, and while the second image is displayed, based on recognizing, via the illuminance sensor, that an ambient illuminance around the electronic device is changed from a first illuminance lower than a first illuminance threshold to a second illuminance higher than the first illuminance threshold, controlling the brightness level of the display by setting the value as a second value lower than the first value.

In accordance with another aspect of the disclosure, a non-transitory computer-readable storage media storing one or more programs including computer-executable instructions that, when executed by one or more processors of an electronic device individually or collectively, cause the electronic device to perform operations, the electronic device including an illuminance sensor and a display are provided. The operations include detecting an event for displaying a first image, based on the event, obtaining a second image that includes a third area corresponding to a first area of the first image, the third area being brighter than the first area, and a fourth area corresponding to a second area of the first image, the fourth area being darker than the second area, controlling a brightness level of the display displaying the second image by setting a value for compensating for the fourth area being darker than the second area as a first value, and while the second image is displayed, based on recognizing, via the illuminance sensor, that an ambient illuminance around the electronic device is changed from a first illuminance lower than a first illuminance threshold to a second illuminance higher than the first illuminance threshold, controlling the brightness level of the display by setting the value as a second value lower than the first value.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of controlling a brightness level of a display of an electronic device according to an ambient illuminance around the electronic device according to an embodiment of the disclosure;

FIG. 2 is a simplified block diagram of an electronic device according to an embodiment of the disclosure;

FIG. 3 is a flowchart illustrating a method of controlling a brightness level of a display displaying a second image generated from a first image according to a change in illuminance according to an embodiment of the disclosure;

FIG. 4 illustrates an example of an event according to an embodiment of the disclosure;

FIG. 5 illustrates a method of generating a second image by applying map information to a first image according to an embodiment of the disclosure;

FIG. 6 illustrates a method of controlling a brightness level of a display displaying a second image according to a change in illuminance according to an embodiment of the disclosure;

FIG. 7 is a flowchart illustrating a method of controlling a brightness level of a display by ceasing a display of a second image and executing a display of a first image according to an embodiment of the disclosure;

FIG. 8 is a block diagram of an electronic device in a network environment according to an embodiment of the disclosure; and

FIG. 9 is a block diagram of a display module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

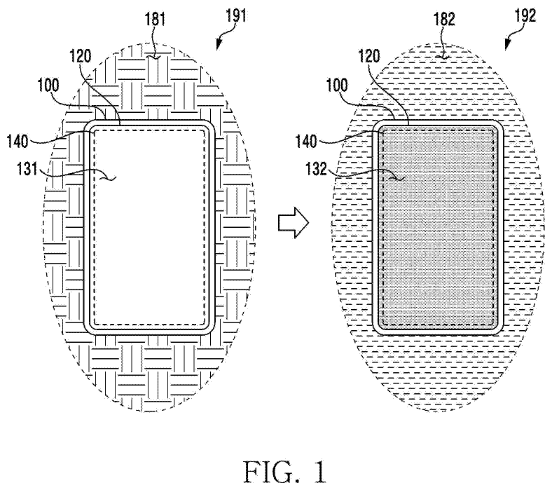

An electronic device may include a display. The display may be used for displaying an image. For example, since the display is exposed to an environment around the electronic device, a visual quality of the image may vary according to a change in the environment. For example, the image may be viewed differently according to an illuminance of the environment. For example, since the image is viewed differently according to the illuminance of the environment, the electronic device may control a brightness level of the display according to the illuminance of the environment. For example, the electronic device may change the brightness level according to a change in the illuminance of the environment. Changing the brightness level is exemplified in the description of FIG. 1.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates an example of controlling a brightness level of a display of an electronic device according to an ambient illuminance around the electronic device according to an embodiment of the disclosure.

Referring to FIG. 1, an electronic device 100 may display, on a display 120, an image 140 at a first brightness level 131, as in a state 191. For example, the first brightness level 131 may correspond to an illuminance 181 around the electronic device 100.

For example, an ambient illuminance around the electronic device 100 may be changed. For example, the ambient illuminance around the electronic device 100 may be changed from the illuminance 181 to an illuminance 182. Maintaining a brightness level of the display 120 displaying the image 140 at the first brightness level 131 corresponding to the illuminance 181 while the ambient illuminance around the electronic device 100 remains the illuminance 182 may reduce a visual quality of the image 140. For example, the electronic device 100 may change the state 191 to a state 192 according to a change from the illuminance 181 to the illuminance 182 for the visual quality of the image 140. For example, as in the state 192, the electronic device 100 may display the image 140 at a second brightness level 132 changed from the first brightness level 131 on the display 120, according to the illuminance 182 changed from the illuminance 181, for the visual quality of the image 140. For example, the second brightness level 132 may correspond to the illuminance 182.

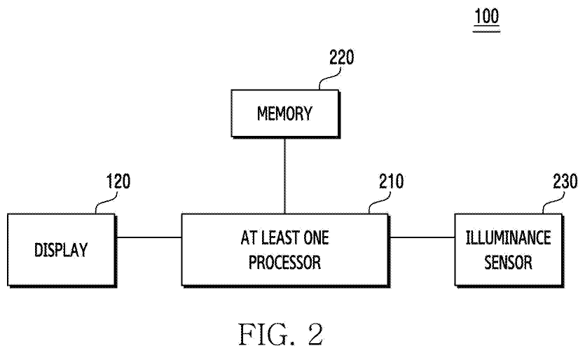

As described above, the electronic device 100 may support a function of controlling a brightness level of the display 120 (e.g., from the first brightness level 131 to the second brightness level 132) according to a change in an ambient illuminance around the electronic device 100 (e.g., a change from the illuminance 181 to the illuminance 182). As a non-limiting example, the function may be used for the electronic device 100 located outdoors. Components of the electronic device 100 for providing the function are exemplified in the description of FIG. 2.

FIG. 2 is a simplified block diagram of an electronic device according to an embodiment of the disclosure.

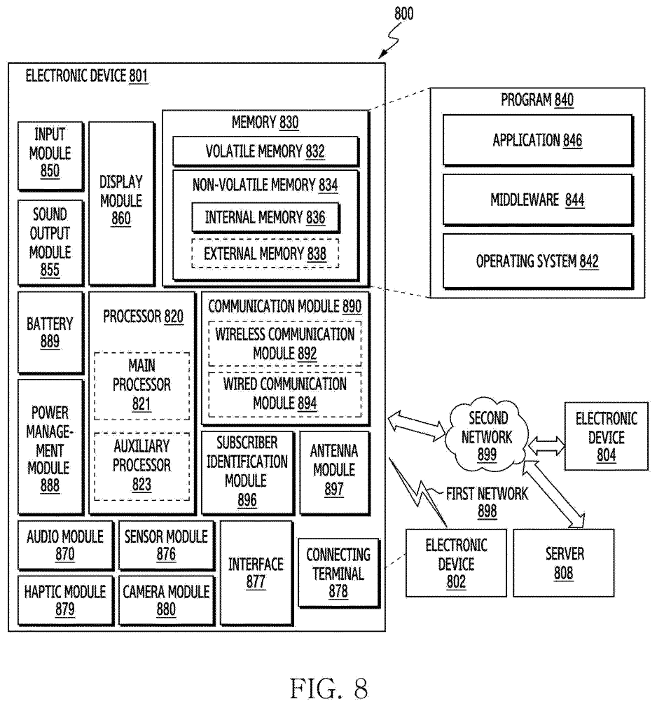

Referring to FIG. 2, the electronic device 100 may include at least a portion of an electronic device 801 of FIG. 8 or may correspond to at least a portion of the electronic device 801 of FIG. 8. The electronic device 100 may include a display 120, at least one processor 210, memory 220, and an illuminance sensor 230. The components exemplified above (e.g., the display 120, the processor 210, the memory 220, and the illuminance sensor 230) are merely. For example, the electronic device 100 may include other components (e.g., power management integrated circuitry (PMIC), or a rechargeable battery). For example, some components may be omitted from the electronic device 100. For example, some components may be integrated into one component.

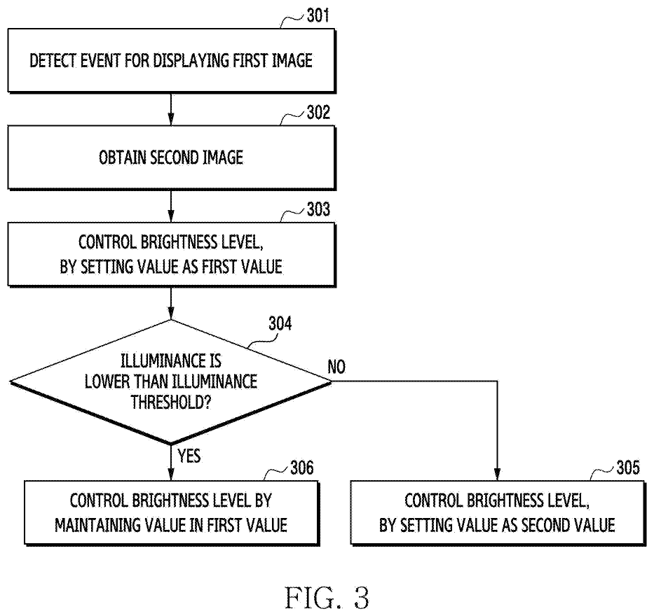

The at least one processor 210 may include at least a portion of a processor 820 of FIG. 8 or may correspond to at least a portion of the processor 820 of FIG. 8. The at least one processor 210 may be used for controlling the display 120, the memory 220, and the sensor 230. The at least one processor 210 may be configured to cause the electronic device 100 to execute at least a portion of operations exemplified in the description of FIGS. 3 to 7 below. For example, the at least one processor 210 may execute at least a portion of the operations exemplified in the description of FIGS. 3 to 7 by executing instructions stored in the memory 220.

The at least one processor 210 may be implemented with one or more integrated circuitry (IC) chips, and may execute various data processing. The at least one processor 210 may include at least one electrical circuitry, and may individually or collectively perform distributed processing of instructions (or programs, data, and the like) stored in the memory 220. The at least one processor 210 may include a processor assembly including one or more processing circuitry. The at least one processor 210 may include any processing circuitry operative for controlling performance and operations of one or more components of the electronic device 100.

The at least one processor 210 may include at least a portion of a processor 820 of FIG. 8 or may correspond to at least a portion of the processor 820 of FIG. 8. For example, the at least one processor 210 may include a central processing unit (CPU) (or central processing circuitry). For example, the at least one processor 210 may include a graphic processing unit (GPU) (or graphic processing circuitry). For example, the at least one processor 210 may include a display processing unit (DPU) (or display control circuitry) for the display 120. For example, the at least one processor 210 may include a memory controller (or memory control circuitry) for the memory 220 (e.g., a volatile memory) and/or a storage controller (or storage control circuitry) for the memory 220 (e.g., a non-volatile memory). For example, the at least one processor 210 may include a sensor interface (or a sensor hub) (or sensor control circuitry) for the illuminance sensor 230.

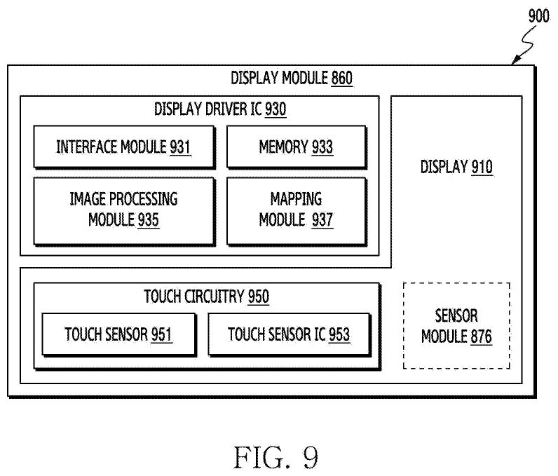

The display 120 may include at least a portion of a display module 860 of FIGS. 8 and 9 or may correspond to at least a portion of the display module 860 of FIGS. 8 and 9. The display 120 may be used for displaying an image (e.g., visual information, visual data, and/or a screen). For example, the display 120 may be used for displaying the image obtained (or generated) (or rendered) by the at least one processor 210. For example, the display 120 may be used for displaying the image provided from the at least one processor 210.

Although not illustrated in FIG. 2, the display 120 may include display driver circuitry (e.g., the display driver IC (DDI) 930 of FIG. 9) and a display panel (e.g., the display 910 of FIG. 9). For example, the display driver circuitry may be used for displaying the image on the display panel. As a non-limiting example, the display driver circuitry may include memory (e.g., graphic random access memory (GRAM)) configured to store information on at least a portion of the image. As a non-limiting example, the display driver circuitry may not include the memory. As a non-limiting example, the display driver circuitry may be configured to operate for a command mode of mobile industry processor interface (MIPI) display serial interface (DSI), a video mode of the MIPI DSI, and/or a video hybrid mode of the MIPI DSI. As a non-limiting example, the display driver circuitry may be configured to execute at least a portion of operations exemplified in the description of FIGS. 3 to 7. For example, a portion of operations of the at least one processor 210 exemplified in the description of FIGS. 3 to 7 may be replaced with at least one operation of the display driver circuitry. For example, the display driver circuitry may control the display panel, based on control data (e.g., a control command) from the at least one processor 210.

The memory 220 may include one or more storage medium (or one or more storage devices). For example, the memory 220 may include a memory assembly including one or more storage media. For example, the one or more storage media may include a permanent memory (e.g., a non-volatile memory 834 of FIG. 8) such as a hard drive, a flash memory, a read-only memory (ROM), a semi-permanent memory (e.g., the volatile memory 832 of FIG. 8) such as a random access memory (RAM), any other suitable type of storage (or a storage assembly), or any combination thereof. The memory 220 may include a cache memory which is one or more different types of memory used for temporarily storing data for a function (or feature) of the electronic device 100. As a non-limiting example, the cache memory may be included in the processor 210. The memory 220 may be fixedly embedded in the electronic device 100, or may be incorporated onto one or more suitable types of components (e.g., a subscriber identity module (SIM) card and/or a secure digital (SD) card) capable of being repeatedly inserted into the electronic device 100 and removed from the electronic device 100.

For example, the memory 220 may store one or more software applications such as an operating system (or a system) software application, a firmware software application, a driver software application, a plugin (e.g., add-in, add-on, and/or applet) software application, and/or any other suitable software applications. For example, the one or more software applications may include instructions executable by the at least one processor 210. For example, the memory 220 may store instructions callable by an application programming interface (API). For example, the memory 220 may store instructions in a library.

The memory 220 may include at least a portion of memory 830 of FIG. 8 or may correspond to at least a portion of the memory 830 of FIG. 8. The memory 220 may be configured to store instructions causing the electronic device 100 to execute at least a portion of operations exemplified in the description of FIGS. 3 to 7. The instructions may be executable by the at least one processor 210.

The illuminance sensor 230 may be configured to obtain data regarding a state of ambient light around the electronic device 100. For example, the illuminance sensor 230 may be configured to obtain data indicating the illuminance. As a non-limiting example, the illuminance sensor 230 may be implemented as a camera (not illustrated) of the electronic device 100 facing a first direction toward which the display 120 faces and/or a camera (not illustrated) of the electronic device 100 facing a second direction opposite to the first direction.

For example, the electronic device 100 may execute various operations for controlling a brightness level of the display 120 according to a change in an ambient illuminance around the electronic device 100 by using components exemplified in the description of FIG. 2.

For example, the electronic device 100 may control a brightness level of the display 120 displaying a second image generated from the first image according to the change in the ambient illuminance. This operation is exemplified in the description of FIG. 3.

FIG. 3 is a flowchart illustrating a method of controlling a brightness level of a display displaying a second image generated from a first image according to a change in illuminance according to an embodiment of the disclosure.

Referring to FIG. 3, in operation 301, the at least one processor 210 may detect an event for displaying a first image. For example, the event may be detected while a brightness level of the display 120 is set to a first brightness level. As a non-limiting example, operation 301 may be executed while an ambient illuminance around the electronic device 100 is a first illuminance. For example, the first brightness level may correspond to the first illuminance. For example, the at least one processor 210 may recognize that the illuminance is the first illuminance according to data (or a signal) obtained from the illuminance sensor 230, while operation 301 is executed. As a non-limiting example, the first illuminance may be lower than an illuminance threshold to be exemplified below.

As a non-limiting example, a file including the first image may include the first image and metadata available for the first image. The metadata will be described in more detail below.

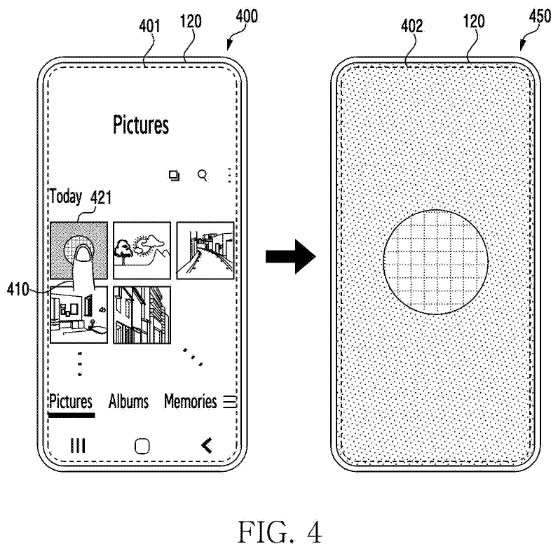

The event may indicate any suitable event causing the display 120 to display the first image. For example, the event may indicate an event changing (or switching) an image displayed on the display 120 to the first image. The event is exemplified in the description of FIG. 4.

FIG. 4 illustrates an example of an event according to an embodiment of the disclosure.

Referring to FIG. 4, the at least one processor 210 may display an image 401 on the display 120, as in a state 400. For example, the image 401 may include a thumbnail image 421 corresponding to the first image exemplified in the description of FIG. 3. For example, the thumbnail image 421 may include a reduced image of the first image. For example, the at least one processor 210 may receive a touch input 410 to the thumbnail image 421 in the state 400. For example, the at least one processor 210 may detect the event by receiving the touch input 410. For example, the at least one processor 210 may change the state 400 to a state 450, based on the touch input 410. For example, the touch input 410 may cause a change from the state 400 to the state 450. For example, the at least one processor 210 may change the state 400 to the state 450, based on the touch input 410 (or in response to the touch input 410). For example, the at least one processor 210 may display a second image 402 generated from the first image on the display 120 in the state 450.

Referring back to FIG. 3, in operation 302, the at least one processor 210 may obtain a second image that includes a third area corresponding to a first area of the first image and brighter than the first area and a fourth area corresponding to a second area of the first image and darker than the second area, based on the event (or based on the detection).

As a non-limiting example, the at least one processor 210 may generate the second image using the first image before detecting the event (e.g., before operation 301) and store the generated second image in the memory 220. For example, the at least one processor 210 may obtain the second image from the memory 220, based on the event.

As a non-limiting example, the at least one processor 210 may obtain the second image by generating the second image using the first image, based on the event.

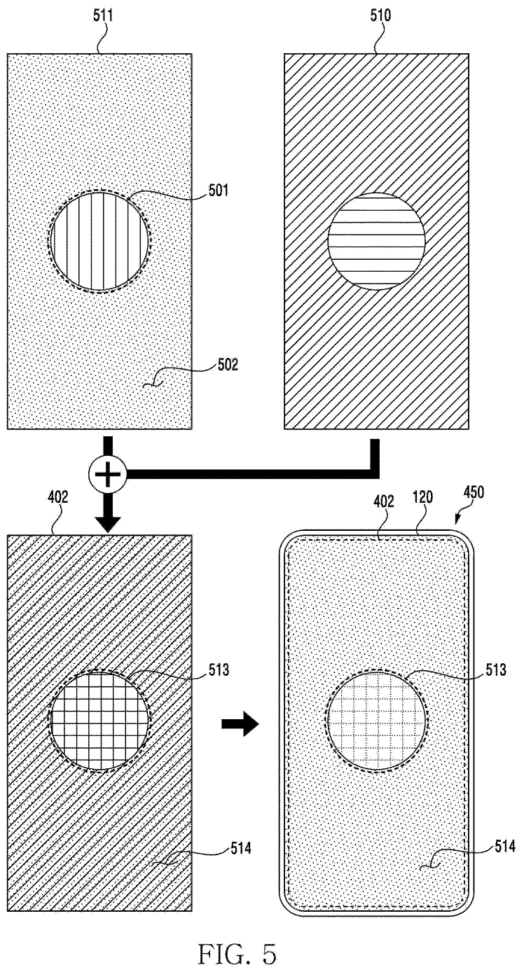

Generating the second image that includes the third area brighter than the first area of the first image and the fourth area darker than the second area of the first image is exemplified in the description of FIG. 5.

FIG. 5 illustrates a method of generating a second image by applying map information to a first image according to an embodiment of the disclosure.

Referring to FIG. 5, a file (not illustrated) including a first image 511 may include the first image 511 and map information 510. As a non-limiting example, the map information 510 may be included in metadata (not illustrated) for the first image 511 included in the file.

For example, the first image 511 may include a first area 501 and a second area 502. For example, the map information 510 may be available for a third area 513 of a second image 402 having a second grayscale range wider than a first grayscale range of the first area 501. For example, the map information 510 may be applied to the first image 511 for the third area 513 visually highlighted relative to the first area 501. For example, the map information 510 may be available for converting the first image 511 into the second image 402 such that the first image 511, which is a standard dynamic range (SDR) image, is shown as a high dynamic range (HDR) image. The map information 510 may be referred to as a gain map.

For example, the at least one processor 210 may generate the second image 402 by applying the map information 510 to the first image 511. As a non-limiting example, since the second image 402 is obtained according to applying the map information 510 to the first image 511, the third area 513 of the second image 402 may be brighter than the first area 501 of the first image 511. For example, a maximum value of the second grayscale range may be higher than a maximum value of the first grayscale range. As a non-limiting example, since the second image 402 is obtained according to applying the map information 510 to the first image 511, a fourth area 514 of the second image 402 may be darker than the second area 502 of the first image 511.

Referring back to FIG. 3, in operation 303, the at least one processor 210 may control a brightness level of the display 120 executing a display of the second image provided as a response to the event detected in operation 301, by setting a value for compensating the fourth area darker than the second area as a first value. As a non-limiting example, the value may be referred to as an ‘SDRtoHDR’ ratio. As a non-limiting example, the value may be referred to as display control information.

For example, referring to FIG. 5, since the fourth area 514 of the second image 402 is darker than the second area 502 of the first image 511, the at least one processor 210 may control the brightness level of the display 120 using the first value such that a brightness of the fourth area 514 of the second image 402 displayed on the display 120 corresponds to a brightness of the second area 502 of the first image 511 based on the event.

As a non-limiting example, in a case that an ambient illuminance around the electronic device 100 before (or immediately before) detecting the event is a first illuminance, the brightness level of the display 120 may be set as a first brightness level (e.g., the first brightness level exemplified in the description of FIG. 3) corresponding to the first illuminance according to the function. For example, in a case that the ambient illuminance around the electronic device 100 after (or immediately after) detecting the event is the first illuminance, the brightness level of the display 120 displaying the second image 402 may be set as a second brightness level higher than the first brightness level. For example, the at least one processor 210 may change the brightness level of the display 120 from the first brightness level to the second brightness level according to a display of the second image 402, even when the ambient illuminance around the electronic device 100 is maintained in the first illuminance. For example, the change from the first brightness level to the second brightness level may be executed according to the first value. For example, the first value may correspond to a difference between the first brightness level and the second brightness level. For example, the first value may correspond to a difference between a brightness of the second area 502 of the first image 511 and a brightness of the fourth area 514 of the second image 402.

For example, the first value may be included in the metadata in a file including the first image 511. For example, the metadata may indicate that the value is the first value. For example, based on the event, the at least one processor 210 may obtain the first value from the metadata, and may control the brightness level of the display 120 executing the display of the second image provided as a response to the event by using the first value (or by setting the value as the first value).

For example, the at least one processor 210 may display the second image 402 on the display 120, according to control of the brightness level exemplified above, as in the state 450. For example, the fourth area 514 of the second image 402 displayed on the display 120 may have a brightness corresponding to the second area 502 of the first image 511, as in the state 450.

Referring back to FIG. 3, the at least one processor 210 may obtain data indicating an ambient illuminance around the electronic device 100 from the illuminance sensor 230 used for the function, while the second image is displayed on the display 120 according to operation 303. For example, the at least one processor 210 may recognize a change in the ambient illuminance around the electronic device 100 by using the illuminance sensor 230, while the second image is displayed on the display 120 according to operation 303.

In operation 304, the at least one processor 210 may determine or check or identify or monitor whether the ambient illuminance around the electronic device 100 is lower than an illuminance threshold, based on recognizing the change in the ambient illuminance around the electronic device 100. As a non-limiting example, operation 304 (e.g., comparing the ambient illuminance around the electronic device 100 indicated by data obtained through the illuminance sensor 230 with the illuminance threshold) may be executed on a condition that the function is activated in the electronic device 100 and the second image is displayed on the display 120 according to an event for the first image.

For example, the at least one processor 210 may execute operation 305 based on recognizing, through the illuminance sensor 230, that the ambient illuminance around the electronic device 100 is changed from the first illuminance lower than the illuminance threshold to a second illuminance higher than the illuminance threshold while the second image is displayed according to operation 303, and may execute operation 306 based on recognizing, through the illuminance sensor 230, that the ambient illuminance around the electronic device 100 is changed from the first illuminance lower than the illuminance threshold to a third illuminance higher than the first illuminance and lower than the illuminance threshold while the second image is displayed according to operation 303.

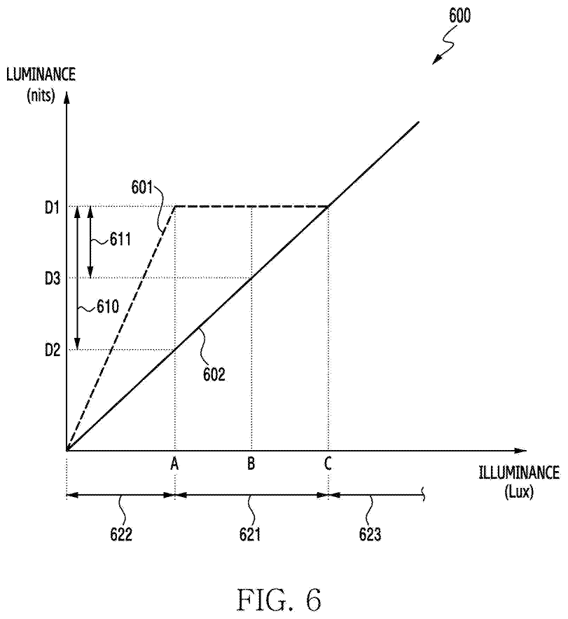

In operation 305, the at least one processor 210 may control the brightness level of the display 120, by setting the value as a second value lower than the first value, on a condition that the ambient illuminance around the electronic device 100 is changed from the first illuminance to the second illuminance. This operation is exemplified in the description of FIG. 6.

FIG. 6 illustrates a method of controlling a brightness level of a display displaying a second image according to a change in illuminance according to an embodiment of the disclosure.

Referring to FIG. 6, a chart 600 represents a change in luminance of the display 120 (the display 120 displaying the second image (e.g., the second image 402)) changed according to a change in illuminance. A horizontal axis of the chart 600 indicates the illuminance, and a vertical axis of the chart 600 indicates the luminance.

A line 601 in the chart 600 is related to luminance of a first position (hereinafter, a first luminance) which is a position in a third area 513 of the second image 402 displayed on the display 120 according to operation 303. For example, the line 601 indicates the first luminance changed according to the change in the illuminance. A line 602 in the chart 600 is related to luminance of a second position (hereinafter, a second luminance) which is a position in a fourth area 514 of the second image 402 displayed on the display 120 according to operation 303. For example, the line 602 indicates the second luminance changed according to the change in the illuminance. For example, since the line 601 indicates a relationship between the illuminance and the first luminance and the line 602 indicates a relationship between the illuminance and the second luminance, a difference 610 (or a ratio 610) between the first luminance D1 indicated by the line 601 when the illuminance is A and the second luminance D2 indicated by the line 602 when the illuminance is A corresponds to the first value. For example, for the same illuminance, a difference (or a ratio) between luminance indicated by the line 601 and luminance indicated by the line 602 indicates the value.

As a non-limiting example, operation 305 executed by the at least one processor 210 may be represented as the line 601 within an illuminance range 621 (e.g., including the second illuminance) and the line 602 within the illuminance range 621. For example, A which is a minimum illuminance of the illuminance range 621 indicates the illuminance threshold. For example, since the first luminance indicated by the line 601 within the illuminance range 621 is maintained according to saturation of luminance and the second luminance indicated by the line 602 within the illuminance range 621 is increased, a difference (or a ratio) between the first luminance indicated by the line 601 within the illuminance range 621 and the second luminance indicated by the line 602 within the illuminance range 621 corresponds to the second value lower than the first value. For example, as indicated by the line 601 within the illuminance range 621 and the line 602 within the illuminance range 621, the at least one processor 210 may control the brightness level of the display 120 displaying the second image, by decreasing the value as the illuminance (e.g., an illuminance higher than the illuminance threshold) recognized through the illuminance sensor 230 increases within the illuminance range 621. As a non-limiting example, the at least one processor 210 may control the brightness level of the display 120 according to obtaining the second image including the fourth area having a second brightness higher than a first brightness of the fourth area of the second image obtained while the illuminance is the first illuminance, based on recognizing that the illuminance is changed from the first illuminance to the second illuminance while the second image is displayed. As a non-limiting example, the at least one processor 210 may control the brightness level of the display 120 by setting the value as the second value according to obtaining the second image including the fourth area having the second brightness higher than the first brightness of the fourth area of the second image obtained while the illuminance is the first illuminance, based on recognizing that the illuminance is changed from the first illuminance to the second illuminance while the second image is displayed. As a non-limiting example, the at least one processor 210 may control the brightness level of the display 120 according to obtaining the second image including the third area having a fourth brightness corresponding to (or substantially the same as) a third brightness of the third area of the second image obtained while the illuminance is the first illuminance and the fourth area having the second brightness, based on recognizing that the illuminance is changed from the first illuminance to the second illuminance while the second image is displayed. As a non-limiting example, the at least one processor 210 may control the brightness level of the display 120 by setting the value as the second value according to obtaining the second image including the third area having the fourth brightness and the fourth area having the second brightness, based on recognizing that the illuminance is changed from the first illuminance to the second illuminance while the second image is displayed.

As a non-limiting example, in order to enhance visibility of an image displayed on the display 120 of the electronic device 100 located outdoors, the electronic device 100 may support another function for controlling a contrast ratio of the image. As a non-limiting example, the another function may be activated (or executed) when the illuminance is B within the illuminance range 621. For example, a difference 611 (or a ratio 611) between the first luminance D1 indicated by the line 601 when the illuminance is B and the second luminance D3 indicated by the line 602 when the illuminance is B may be set as a value for reducing occurrence of a side effect (e.g., a false contour) within the second image displayed on the display 120 according to the another function.

Referring back to FIG. 3, in operation 306, the at least one processor 210 may control the brightness level of the display 120 by maintaining the value in the first value, on a condition that the illuminance is changed from the first illuminance to the third illuminance higher than the first illuminance and lower than the illuminance threshold. This operation is exemplified in the description of FIG. 6.

Referring back to FIG. 6, operation 306 executed by the at least one processor 210 may be represented as a line 601 within an illuminance range 622 (e.g., including the first illuminance and the third illuminance) and a line 602 within the illuminance range 622. For example, since the first luminance indicated by the line 601 within the illuminance range 622 is increased according to a first slope and the second luminance indicated by the line 602 within the illuminance range 622 is increased according to a second slope lower than the first slope, a difference (or a ratio) between the first luminance indicated by the line 601 within the illuminance range 622 and the second luminance indicated by the line 602 within the illuminance range 622 corresponds to the first value. For example, as indicated by the line 601 within the illuminance range 622 and the line 602 within the illuminance range 622, the at least one processor 210 may control the brightness level of the display 120 displaying the second image by maintaining the value in the first value, independently of increase of the illuminance recognized through the illuminance sensor 230, within the illuminance range 622. In this document, maintaining the value in the first value indicates only that a ratio between the first luminance indicated by the line 601 within the illuminance range 622 and the second luminance indicated by the line 602 within the illuminance range 622 is maintained, and it should be noted that it does not indicate that the first luminance indicated by the line 601 within the illuminance range 622 and the second luminance indicated by the line 602 within the illuminance range 622 are fixed.

As described above, the electronic device 100 may enhance a quality of a service provided through the display 120, by executing operations exemplified in the description of FIG. 3, according to a change in illuminance caused while displaying the second image.

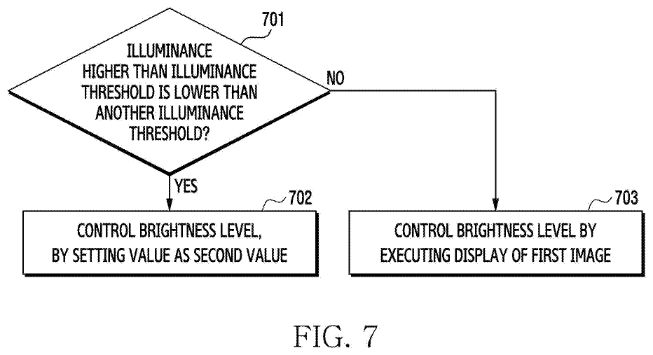

As a non-limiting example, the electronic device 100 may be located in an environment having an illuminance (e.g., a fourth illuminance in the description of FIG. 7) being (much) higher than the second illuminance. For example, the electronic device 100 may support an operation according to another illuminance threshold higher than the illuminance threshold exemplified above for displaying in the environment. This operation is exemplified in the description of FIG. 7.

FIG. 7 is a flowchart illustrating a method of controlling a brightness level of a display by ceasing a display of a second image and executing a display of a first image according to an embodiment of the disclosure.

Referring to FIG. 7, in operation 701, the at least one processor 210 may determine or check or identify or monitor whether the illuminance higher than the illuminance threshold is lower than the another illuminance threshold, based on recognizing a change in the illuminance through the illuminance sensor 230. As a non-limiting example, operation 701 (e.g., comparing the illuminance indicated by data obtained through the illuminance sensor 230 with the another illuminance threshold) may be executed on a condition that the function is activated in the electronic device 100 and the second image is displayed on the display 120 according to an event for the first image.

For example, the at least one processor 210 may execute operation 702 based on recognizing, through the illuminance sensor 230, that the ambient illuminance around the electronic device 100 is changed from the first illuminance to the second illuminance higher than the illuminance threshold and lower than the another illuminance threshold while the second image is displayed according to operation 303, and may execute operation 703 based on recognizing, through the illuminance sensor 230, that the ambient illuminance around the electronic device 100 is changed from the first illuminance to a fourth illuminance higher than the another illuminance threshold while the second image is displayed according to operation 303.

In operation 702, the at least one processor 210 may control the brightness level of the display 120 by setting the value as a second value lower than the first value on a condition that the ambient illuminance around the electronic device 100 is changed from the first illuminance to the second illuminance. For example, operation 702 may correspond to operation 305 of FIG. 3.

In operation 703, the at least one processor 210 may control the brightness level of the display 120 by ceasing the display of the second image and executing a display of the first image on a condition that the ambient illuminance around the electronic device 100 is changed from the first illuminance to the fourth illuminance. This operation is exemplified in the description of FIG. 6.

Referring to FIG. 6, operation 703 executed by the at least one processor 210 may be represented by the line 601 not defined within an illuminance range 623 and the line 602 within the illuminance range 623 (e.g., including the fourth illuminance). For example, C which is a minimum illuminance of the illuminance range 623 indicates the another illuminance threshold. For example, as in the line 601 not defined within the illuminance range 623, the at least one processor 210 may cease the display of the second image on the display 120 and may display the first image on the display 120, based on recognizing the fourth illuminance through the illuminance sensor 230. As a non-limiting example, the at least one processor 210 may increase the brightness level of the display 120 displaying the first image changed from the second image as the ambient illuminance around the electronic device 100 recognized through the illuminance sensor 230 increases within the illuminance range 623.

As described above, the electronic device 100 may support a first function of displaying an SDR image shown as an HDR image and a second function of changing a brightness level of the display 120 according to a change in an ambient illuminance around the electronic device 100. For example, the electronic device 100 may provide an enhanced service by executing the operations exemplified above on a condition that both the first function and the second function are executed.

The operations exemplified above may also be executed by an electronic device 801 to be exemplified in the following description.

FIG. 8 is a block diagram illustrating an electronic device 801 in a network environment 800 according to an embodiment of the disclosure.

Referring to FIG. 8, the electronic device 801 in the network environment 800 may communicate with an electronic device 802 via a first network 898 (e.g., a short-range wireless communication network), or at least one of an electronic device 804 or a server 808 via a second network 899 (e.g., a long-range wireless communication network). According to an embodiment, the electronic device 801 may communicate with the electronic device 804 via the server 808. According to an embodiment, the electronic device 801 may include a processor 820, memory 830, an input module 850, a sound output module 855, a display module 860, an audio module 870, a sensor module 876, an interface 877, a connecting terminal 878, a haptic module 879, a camera module 880, a power management module 888, a battery 889, a communication module 890, a subscriber identification module (SIM) 896, or an antenna module 897. In some embodiments, at least one of the components (e.g., the connecting terminal 878) may be omitted from the electronic device 801, or one or more other components may be added in the electronic device 801. In some embodiments, some of the components (e.g., the sensor module 876, the camera module 880, or the antenna module 897) may be implemented as a single component (e.g., the display module 860).

The processor 820 may execute, for example, software (e.g., a program 840) to control at least one other component (e.g., a hardware or software component) of the electronic device 801 coupled with the processor 820, and may perform various data processing or computation. According to an embodiment, as at least part of the data processing or computation, the processor 820 may store a command or data received from another component (e.g., the sensor module 876 or the communication module 890) in volatile memory 832, process the command or the data stored in the volatile memory 832, and store resulting data in non-volatile memory 834. According to an embodiment, the processor 820 may include a main processor 821 (e.g., a central processing unit (CPU) or an application processor (AP)), or an auxiliary processor 823 (e.g., a graphics processing unit (GPU), a neural processing unit (NPU), an image signal processor (ISP), a sensor hub processor, or a communication processor (CP)) that is operable independently from, or in conjunction with, the main processor 821. For example, when the electronic device 801 includes the main processor 821 and the auxiliary processor 823, the auxiliary processor 823 may be adapted to consume less power than the main processor 821, or to be specific to a specified function. The auxiliary processor 823 may be implemented as separate from, or as part of the main processor 821.

The auxiliary processor 823 may control at least some of functions or states related to at least one component (e.g., the display module 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). According to an embodiment, the auxiliary processor 823 (e.g., an image signal processor or a communication processor) may be implemented as part of another component (e.g., the camera module 880 or the communication module 890) functionally related to the auxiliary processor 823. According to an embodiment, the auxiliary processor 823 (e.g., the neural processing unit) may include a hardware structure specified for artificial intelligence model processing. An artificial intelligence model may be generated by machine learning. Such learning may be performed, e.g., by the electronic device 801 where the artificial intelligence is performed or via a separate server (e.g., the server 808). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834.

The program 840 may be stored in the memory 830 as software, and may include, for example, an operating system (OS) 842, middleware 844, or an application 846.

The input module 850 may receive a command or data to be used by another component (e.g., the processor 820) of the electronic device 801, from the outside (e.g., a user) of the electronic device 801. The input module 850 may include, for example, a microphone, a mouse, a keyboard, a key (e.g., a button), or a digital pen (e.g., a stylus pen).

The sound output module 855 may output sound signals to the outside of the electronic device 801. The sound output module 855 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 860 may visually provide information to the outside (e.g., a user) of the electronic device 801. The display module 860 may include, for example, a display, a hologram device, or a projector and control circuitry to control a corresponding one of the display, hologram device, and projector. According to an embodiment, the display module 860 may include a touch sensor adapted to detect a touch, or a pressure sensor adapted to measure the intensity of force incurred by the touch.

The audio module 870 may convert a sound into an electrical signal and vice versa. According to an embodiment, the audio module 870 may obtain the sound via the input module 850, or output the sound via the sound output module 855 or a headphone of an external electronic device (e.g., an electronic device 802) directly (e.g., wiredly) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. According to an embodiment, the sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device (e.g., the electronic device 802) directly (e.g., wiredly) or wirelessly. According to an embodiment, the interface 877 may include, for example, a high definition multimedia interface (HDMI), a universal serial bus (USB) interface, a secure digital (SD) card interface, or an audio interface.

A connecting terminal 878 may include a connector via which the electronic device 801 may be physically connected with the external electronic device (e.g., the electronic device 802). According to an embodiment, the connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or electrical stimulus which may be recognized by a user via his tactile sensation or kinesthetic sensation. According to an embodiment, the haptic module 879 may include, for example, a motor, a piezoelectric element, or an electric stimulator.

The camera module 880 may capture a still image or moving images. According to an embodiment, the camera module 880 may include one or more lenses, image sensors, image signal processors, or flashes.

The power management module 888 may manage power supplied to the electronic device 801. According to an embodiment, the power management module 888 may be implemented as at least part of, for example, a power management integrated circuit (PMIC).

The battery 889 may supply power to at least one component of the electronic device 801. According to an embodiment, the battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the application processor (AP)) and supports a direct (e.g., wired) communication or a wireless communication. According to an embodiment, the communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as Bluetooth™, wireless-fidelity (Wi-Fi) direct, or infrared data association (IrDA)) or the second network 899 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 892 may identify and authenticate the electronic device 801 in a communication network, such as the first network 898 or the second network 899, using subscriber information (e.g., international mobile subscriber identity (IMSI)) stored in the subscriber identification module 896.

The wireless communication module 892 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 892 may support a high-frequency band (e.g., the mmWave band) to achieve, e.g., a high data transmission rate. The wireless communication module 892 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 892 may support various requirements specified in the electronic device 801, an external electronic device (e.g., the electronic device 804), or a network system (e.g., the second network 899). According to an embodiment, the wireless communication module 892 may support a peak data rate (e.g., 20 Gbps or more) for implementing eMBB, loss coverage (e.g., 864 dB or less) for implementing mMTC, or U-plane latency (e.g., 0.5 ms or less for each of downlink (DL) and uplink (UL), or a round trip of 8 ms or less) for implementing URLLC.

The antenna module 897 may transmit or receive a signal or power to or from the outside (e.g., the external electronic device) of the electronic device 801. According to an embodiment, the antenna module 897 may include an antenna including a radiating element composed of a conductive material or a conductive pattern formed in or on a substrate (e.g., a printed circuit board (PCB)). According to an embodiment, the antenna module 897 may include a plurality of antennas (e.g., array antennas). In such a case, at least one antenna appropriate for a communication scheme used in the communication network, such as the first network 898 or the second network 899, may be selected, for example, by the communication module 890 (e.g., the wireless communication module 892) from the plurality of antennas. The signal or the power may then be transmitted or received between the communication module 890 and the external electronic device via the selected at least one antenna. According to an embodiment, another component (e.g., a radio frequency integrated circuit (RFIC)) other than the radiating element may be additionally formed as part of the antenna module 897.

According to various embodiments, the antenna module 897 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 801 and the external electronic device 804 via the server 808 coupled with the second network 899. Each of the electronic devices 802 or 804 may be a device of a same type as, or a different type, from the electronic device 801. According to an embodiment, all or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 801. The electronic device 801 may provide the outcome, with or without further processing of the outcome, as at least part of a reply to the request. To that end, a cloud computing, distributed computing, mobile edge computing (MEC), or client-server computing technology may be used, for example. The electronic device 801 may provide ultra low-latency services using, e.g., distributed computing or mobile edge computing. In another embodiment, the external electronic device 804 may include an internet-of-things (IoT) device. The server 808 may be an intelligent server using machine learning and/or a neural network. According to an embodiment, the external electronic device 804 or the server 808 may be included in the second network 899. The electronic device 801 may be applied to intelligent services (e.g., smart home, smart city, smart car, or healthcare) based on 5G communication technology or IoT-related technology.

FIG. 9 is a block diagram 900 illustrating the display module 860 according to an embodiment of the disclosure.

Referring to FIG. 9, the display module 860 may include a display 910 and a display driver integrated circuit (DDI) 930 to control the display 910. The DDI 930 may include an interface module 931, memory 933 (e.g., buffer memory), an image processing module 935, or a mapping module 937. The DDI 930 may receive image information that contains image data or an image control signal corresponding to a command to control the image data from another component of the electronic device 801 via the interface module 931. For example, according to an embodiment, the image information may be received from the processor 820 (e.g., the main processor 821 (e.g., an application processor)) or the auxiliary processor 823 (e.g., a graphics processing unit) operated independently from the function of the main processor 821. The DDI 930 may communicate, for example, with touch circuitry 950 or the sensor module 876 via the interface module 931. The DDI 930 may also store at least part of the received image information in the memory 933, for example, on a frame by frame basis. The image processing module 935 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 910. The mapping module 937 may generate a voltage value or a current value corresponding to the image data pre-processed or post-processed by the image processing module 935. According to an embodiment, the generating of the voltage value or current value may be performed, for example, based at least in part on one or more attributes of the pixels (e.g., an array, such as an RGB stripe or a pentile structure, of the pixels, or the size of each subpixel). At least some pixels of the display 910 may be driven, for example, based at least in part on the voltage value or the current value such that visual information (e.g., a text, an image, or an icon) corresponding to the image data may be displayed via the display 910.

According to an embodiment, the display module 860 may further include the touch circuitry 950. The touch circuitry 950 may include a touch sensor 951 and a touch sensor IC 953 to control the touch sensor 951. The touch sensor IC 953 may control the touch sensor 951 to sense a touch input or a hovering input with respect to a certain position on the display 910. To achieve this, for example, the touch sensor 951 may detect (e.g., measure) a change in a signal (e.g., a voltage, a quantity of light, a resistance, or a quantity of one or more electric charges) corresponding to the certain position on the display 910. The touch circuitry 950 may provide input information (e.g., a position, an area, a pressure, or a time) indicative of the touch input or the hovering input detected via the touch sensor 951 to the processor 820. According to an embodiment, at least part (e.g., the touch sensor IC 953) of the touch circuitry 950 may be formed as part of the display 910 or the DDI 930, or as part of another component (e.g., the auxiliary processor 823) disposed outside the display module 860.

According to an embodiment, the display module 860 may further include at least one sensor (e.g., a fingerprint sensor, an iris sensor, a pressure sensor, or an illuminance sensor) of the sensor module 876 or a control circuit for the at least one sensor. In such a case, the at least one sensor or the control circuit for the at least one sensor may be embedded in one portion of a component (e.g., the display 910, the DDI 930, or the touch circuitry 950)) of the display module 860. For example, when the sensor module 876 embedded in the display module 860 includes a biometric sensor (e.g., a fingerprint sensor), the biometric sensor may obtain biometric information (e.g., a fingerprint image) corresponding to a touch input received via a portion of the display 910. As another example, when the sensor module 876 embedded in the display module 860 includes a pressure sensor, the pressure sensor may obtain pressure information corresponding to a touch input received via a partial or whole area of the display 910. According to an embodiment, the touch sensor 951 or the sensor module 876 may be disposed between pixels in a pixel layer of the display 910, or over or under the pixel layer.

The technical problems to be achieved in this document are not limited to those described above, and other technical problems not mentioned herein will be clearly understood by those having ordinary knowledge in the art to which the disclosure belongs.

As described above, an electronic device (e.g., the electronic device 100) may include memory (e.g., the memory 220) comprising one or more storage media storing instructions, an illuminance sensor (e.g., the illuminance sensor 230), a display (e.g., the display 120), and at least one processor (e.g., the at least one processor 210) including one or more processing circuitry. The at least one processor may detect (e.g., operation 301) an event for displaying a first image, obtain (e.g., operation 302), based on the event, a second image that includes a third area corresponding to a first area of the first image and brighter than the first area and a fourth area corresponding to a second area of the first image and darker than the second area, control (e.g., operation 303) a brightness level of the display executing a display of the second image provided as a response to the event by setting a value for compensating the fourth area darker than the second area as a first value, and control (e.g., operation 305) the brightness level of the display by setting the value as a second value lower than the first value, based on recognizing, through the illuminance sensor, that an ambient illuminance around the electronic device is changed from a first illuminance lower than an illuminance threshold to a second illuminance higher than the illuminance threshold, while the second image is displayed.

The at least one processor may be configured to control (e.g., operation 306) the brightness level of the display by maintaining the value in the first value, based on recognizing, through the illuminance sensor, that the ambient illuminance around the electronic device is changed from the first illuminance to a third illuminance higher than the first illuminance and lower than the illuminance threshold, while the second image is displayed.

For example, the second illuminance may be lower than another illuminance threshold higher than the illuminance threshold. The at least one processor may be configured to control (e.g., operation 703) the brightness level of the display, by ceasing the display of the second image and executing a display of the first image, based on recognizing, through the illuminance sensor, that the ambient illuminance around the electronic device is changed from the first illuminance to a fourth illuminance higher than the another illuminance threshold, while the second image is displayed.

The at least one processor may be configured to control (e.g., operation 305) the brightness level of the display, by setting the value as the second value according to obtaining the second image that includes the fourth area having a second brightness higher than a first brightness of the fourth area of the second image obtained while the ambient illuminance around the electronic device remains the first illuminance, based on recognizing that the ambient illuminance around the electronic device is changed from the first illuminance to the second illuminance.

The at least one processor may be configured to control (e.g., operation 305) the brightness level of the display by setting the value as the second value according to obtaining the second image that includes the third area having a fourth brightness corresponding to a third brightness of the third area of the second image obtained while the ambient illuminance around the electronic device remains the first illuminance and the fourth area having the second brightness, based on recognizing that the ambient illuminance around the electronic device is changed from the first illuminance to the second illuminance.

For example, the first value may correspond to a difference between a third brightness of the second area and the first brightness.

The at least one processor may be configured to, before detecting the event, generate the second image, store the generated second image in the memory, and obtain (e.g., operation 302) the second image from the memory based on the event.

The at least one processor may be configured to obtain (e.g., operation 302) the second image by generating the second image based on the event.

For example, the first value may be obtained from metadata in a file, including the first image, stored in the memory.

The at least one processor may be configured to, based on the event, obtain the second image by generating the second image in accordance with applying map information in the metadata for the third area having a second grayscale range wider than a first grayscale range of the first area to the first image, or obtain (e.g., operation 302), from the memory, the second image generated by applying the map information for the third area for the second grayscale range to the first image.

For example, the map information may be applied to the first image for the third area visually highlighted relative to the first area.

As described above, a method may be executed in an electronic device with an illuminance sensor and a display. The method may include detecting an event for displaying a first image, obtaining, based on the event, a second image that includes a third area corresponding to a first area of the first image and brighter than the first area and a fourth area corresponding to a second area of the first image and darker than the second area, controlling a brightness level of the display executing a display of the second image provided as a response to the event by setting a value for compensating the fourth area darker than the second area as a first value, and controlling the brightness level of the display by setting the value as a second value lower than the first value, based on recognizing, through the illuminance sensor, that an ambient illuminance around the electronic device is changed from a first illuminance lower than an illuminance threshold to a second illuminance higher than the illuminance threshold while the second image is displayed.

The method may include controlling the brightness level of the display by maintaining the value in the first value, based on recognizing, through the illuminance sensor, that the ambient illuminance around the electronic device is changed from the first illuminance to a third illuminance higher than the first illuminance and lower than the illuminance threshold, while the second image is displayed.

For example, the second illuminance may be lower than another illuminance threshold higher than the illuminance threshold. The method may include controlling the brightness level of the display by ceasing the display of the second image and executing a display of the first image, based on recognizing, through the illuminance sensor, that the ambient illuminance around the electronic device is changed from the first illuminance to a fourth illuminance higher than the another illuminance threshold, while the second image is displayed.

For example, the controlling the brightness level of the display based on recognizing that the ambient illuminance around the electronic device is changed from the first illuminance to the second illuminance may include controlling the brightness level of the display by setting the value as the second value according to obtaining the second image including the fourth area having a second brightness higher than a first brightness of the fourth area of the second image obtained while the ambient illuminance around the electronic device remains the first illuminance, based on recognizing that the ambient illuminance around the electronic device is changed from the first illuminance to the second illuminance.

For example, the controlling the brightness level of the display based on recognizing that the ambient illuminance around the electronic device is changed from the first illuminance to the second illuminance may include controlling the brightness level of the display by setting the value as the second value according to obtaining the second image that includes the third area having a fourth brightness corresponding to a third brightness of the third area of the second image obtained while the ambient illuminance around the electronic device remains the first illuminance and the fourth area having the second brightness, based on recognizing that the ambient illuminance around the electronic device is changed from the first illuminance to the second illuminance.

As described above, a non-transitory computer-readable storage medium may store one or more programs. The one or more programs may include instructions to, when executed by an electronic device with an illuminance sensor and a display, cause the electronic device to detect an event for displaying a first image, obtain, based on the event, a second image that includes a third area corresponding to a first area of the first image and brighter than the first area and a fourth area corresponding to a second area of the first image and darker than the second area, control a brightness level of the display executing a display of the second image provided as a response to the event by setting a value for compensating the fourth area darker than the second area as a first value, and control the brightness level of the display by setting the value as a second value lower than the first value, based on recognizing, through the illuminance sensor, that an ambient illuminance around the electronic device is changed from a first illuminance lower than an illuminance threshold to a second illuminance higher than the illuminance threshold, while the second image is displayed.

The one or more programs may include instructions causing the electronic device to control the brightness level of the display by maintaining the value in the first value, based on recognizing, through the illuminance sensor, that the ambient illuminance around the electronic device is changed from the first illuminance to a third illuminance higher than the first illuminance and lower than the illuminance threshold, while the second image is displayed.

For example, the second illuminance may be lower than another illuminance threshold higher than the illuminance threshold. The one or more programs may include instructions causing the electronic device to control the brightness level of the display by ceasing the display of the second image and executing a display of the first image, based on recognizing, through the illuminance sensor, that the ambient illuminance around the electronic device is changed from the first illuminance to a fourth illuminance higher than the another illuminance threshold, while the second image is displayed.

The one or more programs may include instructions causing the electronic device to control the brightness level of the display by obtaining the second image including the fourth area having a second brightness higher than a first brightness of the fourth area of the second image obtained while the ambient illuminance around the electronic device is the first illuminance, based on recognizing that the ambient illuminance around the electronic device is changed from the first illuminance to the second illuminance.

The effects that can be obtained from the disclosure are not limited to those described above, and any other effects not mentioned herein will be clearly understood by those having ordinary knowledge in the art to which the disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 840) including one or more instructions that are stored in a storage medium (e.g., internal memory 836 or external memory 838) that is readable by a machine (e.g., the electronic device 801). For example, a processor (e.g., the processor 820) of the machine (e.g., the electronic device 801) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and digital versatile disc (DVD), magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

Although the embodiments have been described above with reference to limited examples and drawings, various modifications and variations may be made from the above description by those skilled in the art. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments therefore, it will be understood by those skilled in the art that various changes in form and details may be made therein without departing from the spirit and scope of the disclosure as defined by the appended claims and their equivalents.

What is claimed is:

1. An electronic device comprising:
memory comprising one or more storage media storing instructions;
an illuminance sensor;
a display; and
at least one processor comprising one or more processing circuitry,
wherein the instructions, when executed by the at least one processor individually or collectively, cause the electronic device to:
detect an event for displaying a first image;
based on the event, obtain a second image that includes:
a third area, corresponding to a first area of the first image, brighter than the first area, and
a fourth area, corresponding to a second area of the first image, darker than the second area;
control a brightness level of the display that executes a display of the second image provided as a response to the event by setting a value for compensating for the fourth area darker than the second area as a first value; and
while the second image is displayed, based on recognizing, via the illuminance sensor, that an ambient illuminance around the electronic device is changed from a first illuminance lower than an illuminance threshold to a second illuminance higher than the illuminance threshold, control the brightness level of the display by setting the value as a second value lower than the first value.

2. The electronic device of claim 1, wherein the instructions, when executed by the at least one processor individually or collectively, cause the electronic device to:
while the second image is displayed, based on recognizing, via the illuminance sensor, that the ambient illuminance around the electronic device is changed from the first illuminance to a third illuminance lower than the illuminance threshold and higher than the first illuminance, control the brightness level of the display by maintaining the value in the first value.

3. The electronic device of claim 2, wherein the second illuminance is lower than another illuminance threshold higher than the illuminance threshold, and
wherein the instructions, when executed by the at least one processor individually or collectively, cause the electronic device to:
while the second image is displayed, based on recognizing, via the illuminance sensor, that the ambient illuminance around the electronic device is changed from the first illuminance to a fourth illuminance higher than the another illuminance threshold, control the brightness level of the display by:
ceasing the display of the second image, and
executing a display of the first image.

4. The electronic device of claim 1, wherein the instructions, when executed by the at least one processor individually or collectively, cause the electronic device to:
based on recognizing that the ambient illuminance around the electronic device is changed from the first illuminance to the second illuminance, control the brightness level of the display by setting the value as the second value in accordance with obtaining the second image that includes: the fourth area having a second brightness higher than a first brightness of the fourth area of the second image obtained while the ambient illuminance around the electronic device remains the first illuminance.

5. The electronic device of claim 4, wherein the instructions, when executed by the at least one processor individually or collectively, cause the electronic device to:
based on recognizing that the ambient illuminance around the electronic device is changed from the first illuminance to the second illuminance, control the brightness level of the display by setting the value as the second value in accordance with obtaining the second image that includes: the third area having a fourth brightness corresponding to a third brightness of the third area of the second image obtained while the ambient illuminance around the electronic device remains the first illuminance, and the fourth area having the second brightness.

6. The electronic device of claim 4, wherein the first value corresponds to a difference between a third brightness of the second area and the first brightness.

7. The electronic device of claim 1, wherein the instructions, when executed by the at least one processor individually or collectively, cause the electronic device to:
before the event is detected, generate the second image and store in the memory the generated second image; and
based on the event, obtain the second image from the memory.

8. The electronic device of claim 1, wherein the instructions, when executed by the at least one processor individually or collectively, cause the electronic device to:
obtain the second image by generating the second image based on the event.

9. The electronic device of claim 1, wherein the first value is obtained from metadata in a file, including the first image, stored in the memory.

10. The electronic device of claim 9, wherein the instructions, when executed by the at least one processor individually or collectively, cause the electronic device to:
based on the event:
obtain the second image by generating the second image in accordance with applying map information in the metadata for the third area having a second grayscale range wider than a first grayscale range of the first area to the first image, or obtain the second image generated by applying the map information for the third area for the second grayscale range to the first image, from the memory.

11. The electronic device of claim 10, wherein the map information is applied to the first image for the third area visually highlighted relative to the first area.

12. A method executed in an electronic device with an illuminance sensor and a display, the method comprising:
detecting an event for displaying a first image;
based on the event, obtaining a second image that includes:
a third area, corresponding to a first area of the first image, brighter than the first area, and
a fourth area, corresponding to a second area of the first image, darker than the second area;
controlling a brightness level of the display that executes a display of the second image provided as a response to the event by setting a value for compensating for the fourth area darker than the second area as a first value; and
while the second image is displayed, based on recognizing, via the illuminance sensor, that an ambient illuminance around the electronic device is changed from a first illuminance lower than a illuminance threshold to a second illuminance higher than the illuminance threshold, controlling the brightness level of the display by setting the value as a second value lower than the first value.

13. The method of claim 12, comprising:
while the second image is displayed, based on recognizing, via the illuminance sensor, that the ambient illuminance around the electronic device is changed from the first illuminance to a third illuminance lower than the illuminance threshold and higher than the first illuminance, controlling the brightness level of the display by maintaining the value in the first value.

14. The method of claim 13, wherein the second illuminance is lower than another illuminance threshold higher than the illuminance threshold, and
wherein the method comprises:
while the second image is displayed, based on recognizing, via the illuminance sensor, that the ambient illuminance around the electronic device is changed from the first illuminance to a fourth illuminance higher than the another illuminance threshold, controlling the brightness level of the display by:
ceasing the display of the second image, and
executing a display of the first image.

15. The method of claim 12, wherein the controlling the brightness level of the display based on recognizing that the ambient illuminance around the electronic device is changed from the first illuminance to the second illuminance comprises:
based on recognizing that the ambient illuminance around the electronic device is changed from the first illuminance to the second illuminance, controlling the brightness level of the display by setting the value as the second value according to obtaining the second image including the fourth area having a second brightness higher than a first brightness of the fourth area of the second image obtained while the ambient illuminance around the electronic device remains the first illuminance.

16. The method of claim 15, wherein the controlling the brightness level of the display based on recognizing that the ambient illuminance around the electronic device is changed from the first illuminance to the second illuminance comprises:
based on recognizing that the ambient illuminance around the electronic device is changed from the first illuminance to the second illuminance, controlling the brightness level of the display by setting the value as the second value according to obtaining the second image that includes the third area having a fourth brightness corresponding to a third brightness of the third area of the second image obtained while the ambient illuminance around the electronic device remains the first illuminance and the fourth area having the second brightness.

17. A non-transitory computer readable storage medium storing one or more programs, the one or more programs including instructions to, when executed by an electronic device with an illuminance sensor and a display, cause the electronic device to:
detect an event for displaying a first image;
based on the event, obtain a second image that includes:
a third area, corresponding to a first area of the first image, brighter than the first area, and
a fourth area, corresponding to a second area of the first image, darker than the second area;
control a brightness level of the display that executes a display of the second image provided as a response to the event by setting a value for compensating for the fourth area darker than the second area as a first value; and
while the second image is displayed, based on recognizing, via the illuminance sensor, that an ambient illuminance around the electronic device is changed from a first illuminance lower than a illuminance threshold to a second illuminance higher than the illuminance threshold, control the brightness level of the display by setting the value as a second value lower than the first value.

18. The non-transitory computer readable storage medium of claim 17, wherein the one or more programs include instructions causing the electronic device to control the brightness level of the display by maintaining the value in the first value, based on recognizing, through the illuminance sensor, that the ambient illuminance around the electronic device is changed from the first illuminance to a third illuminance higher than the first illuminance and lower than the illuminance threshold, while the second image is displayed.

19. The non-transitory computer readable storage medium of claim 18, wherein the second illuminance is lower than another illuminance threshold higher than the illuminance threshold, and
wherein the one or more programs include instructions causing the electronic device to control the brightness level of the display by ceasing the display of the second image and executing a display of the first image, based on recognizing, through the illuminance sensor, that the ambient illuminance around the electronic device is changed from the first illuminance to a fourth illuminance higher than the another illuminance threshold, while the second image is displayed.

20. The non-transitory computer readable storage medium of claim 17, wherein the one or more programs include instructions causing the electronic device to control the brightness level of the display by obtaining the second image including the fourth area having a second brightness higher than a first brightness of the fourth area of the second image obtained while the ambient illuminance around the electronic device is the first illuminance, based on recognizing that the ambient illuminance around the electronic device is changed from the first illuminance to the second illuminance.
